(19) United States
(12) Patent Application Publication
(10) Pub. No.: US 2005/0120735 A1
(43) Pub. Date: Jun. 9, 2005

(54) Daycare center shopping module

(76) Inventor: Eugenia E. Noble, Boca Raton, FL (US)

Correspondence Address: MALIN HALEY AND DIMAGGIO, PA, 1936 S ANDREWS AVENUE, FORT LAUDERDALE, FL, 33316, US

(21) Appl. No.: 10/766,093

(22) Filed: Jan. 27, 2004

Related U.S. Application Data
(60) Provisional application No. 60/443,056, filed on Jan. 28, 2003.

(51) Int. Cl. A23G 9/00

(52) U.S. Cl. 62/342

(57) ABSTRACT

A method and system for greatly reducing the amount of stop and go driving and shopping of a child caretaker that requires the transport of the child to and from a child activity center by providing kiosk units that allow for the purchase of child specialty products with the kiosk center being mounted directly in the storage space at the child activity center such as a hallway in a daycare center. The system allows for an attendant with lock and key and a merchant access device for credit cards to sell child specialty products conveniently and easily at the daycare center. The kiosk owner maintains the transport of goods, the shelves of which are labeled with each of the goods for sale and can be seen clearly through glass windows mounted on each of the doors including a refrigerator. A drive through kiosk can be provided selling child specialty products.

This application claims the benefit of and priority to U.S. Provisional Patent Application Ser. No. 60/443,056 filed Jan. 28, 2003.

### BACKGROUND OF THE INVENTION

1. Field of the Invention

This invention relates generally to a shopping module and kiosk especially for the convenience of parents of young children, and specifically to a shopping module and kiosk for daycare centers that provide added convenience to parents who have young children that are transported to and from daycare centers to eliminate unnecessary side trips and stops to one or more other stores while caring for an infant. The invention also includes a drive through shopping facility that sells primary children related items for convenience to parents.

2. Description of Related Art

Mothers and fathers of young children in today's age experience a very hectic schedule. Many pre-school children and school children require all day or part-time childcare in daycare centers during the work week. Many young children have special needs when it comes to particular products that must be purchased on a periodic regular basis such as diapers, special milk or food products, and other necessities. For the parent of a young child that has to be transported back and forth to a daycare or dropped off and picked up at school many times a week, the child must ride in a special car seat for extra protection of the child. This makes stopping even at a convenience store or a supermarket an extra chore because of the extra requirement of transporting a small child, removing the child from the car seat and taking the child in and out of the store.

The present invention greatly alleviates the hectic travel schedule of a parent of a young child by providing a shopping module or kiosk that can be easily and rapidly installed in a daycare center, an elementary school or pre-school environment that allows the parent to obtain necessary items required by a child on a periodic basis conveniently and quickly at the shopping kiosk located at the daycare center, alleviating the extra trip and stop to a grocery store or convenience store, greatly saving time for the parent and increased safety to the child.

The present invention includes a drive through shopping store having items required by children for the convenience of parents required to transport children so that the parent need not park or leave the automobile to purchase certain child specific items such as diapers and baby food. Most vehicles are required to have child restraint systems. Removing and inserting a child from and into the child restraint system in the vehicle is very time consuming . . . With a drive through store that specializes in a child's necessities the child care provider does not have to leave the vehicle to purchase these items.

### SUMMARY OF THE INVENTION

A shopping kiosk and module especially suited for a daycare center to provide purchasable items required for small children especially on a periodic basis for rapid sale to a customer at the daycare center comprising a first module storage center that contains children's products such as diapers, children's baby food, baby bottles, a lockable display cabinet for securely storing said children's items, optionally a credit card transaction device for allowing customers to independently charge items obtained from said shopping module directly to a credit card connection to eliminate the need for exchanging money during the sales transactions, a computer for keeping track of the items being sold and the authorization for a particular customer, store value card prepaid (a membership card) required by the customer relating to the daycare center membership and the store value card prepaid (customer membership) and credit card to allow the party to access the kiosk at the daycare center. A cash register can be used by a daycare employee who operates the kiosk for the daycare center.

The method of the invention includes the installation of a shopping kiosk in a daycare center or school center that provides items specifically useful for young children including diapers and baby foods, snacks, and medicine required by a young child in conjunction with other items to allow a person who has a child in the daycare center or school environment to access items needed by the child depending on the age group to avoid having made additional transport or vehicle stops en route between picking the child up or dropping the child off at daycare. The process would then include providing for the combination of having a student or child in a daycare center in which the child is transported to the daycare center and then transported home and at the same time allowing the participant who transports the child to and from a daycare center during a work day to also participate in shopping while at the daycare center, alleviating extra trips and transport to stores and stops in order to get specific items needed by the child throughout the day such as diapers or the like.

Therefore, the essence of the invention is the combination of providing a daycare center with a shopping venue that can be one or more modules and optionally electronically connected to the shopping commercial credit card center to avoid having independent monetary transactions at the site allowing for an independent access by the daycare participant. An important aspect of the invention is to provide one or more small consumer items storage and display modules that do not take up much space, that could be termed a kiosk, that allows for securely storing items to be purchased such as diapers, baby aspirin and baby food to be strategically located in a daycare center. The kiosk provides instant access for the user (such as the parent or custodian of a child who brings and/or picks up the child from daycare) access to the shopping venue that can be made through the use of a cash register and attendant, smart card or credit card. The consumer item storage units can be secured and locked up when not in use by the caretakers of the daycare center.

In an alternate embodiment, the shopping kiosk concept can be extending to a drive through store conveniently located to allow the child transporting parent to shop and purchase child necessities directly at a drive though store. The store front and signage can have aesthetic child decor such as the crayon display units for rapid identification for drivers and to entertain the children as they sit in the vehicles. An attendant at the store sells items directly to the driver who pays the attendant. A decorative display lists the items available with a price. This store operation provides convenience and safety for the child care giver.

It is an object of this invention to provide an improved daycare center that includes a compact secure shopping site for children items such as diapers, medicines, foods and the like to allow the parent or child custodian to purchase items at the daycare center to alleviate having to go to stores to shop for the same items.

In accordance with these and other objects which will become apparent hereinafter, the instant invention will now be described with particular reference to the accompanying drawings.

### BRIEF DESCRIPTION OF THE DRAWINGS

FIG. 1 shows a front elevational view of a daycare kiosk in accordance with the present invention.

FIG. 2 shows a side perspective view of the present invention on the front side.

FIG. 3 shows a front perspective view of the refrigeration mounted in the present invention.

FIG. 4 shows a front view of the storage cabinets used with the present invention.

FIG. 5 shows a front view partial cutaway of the storage shelves and front glass casing of the present invention.

FIG. 6 shows a close up front view partially cutaway of the storage shelves and shelf tags a product identification used in the present invention.

FIG. 7 shows a perspective view of a credit card system that can be used with the present invention.

FIG. 8 shows a perspective view of one storage module used with the present invention.

FIG. 9 is a front elevational view presenting two storage modules and exploded view of the connectors panels used therewith.

### PREFERRED EMBODIMENT OF THE INVENTION

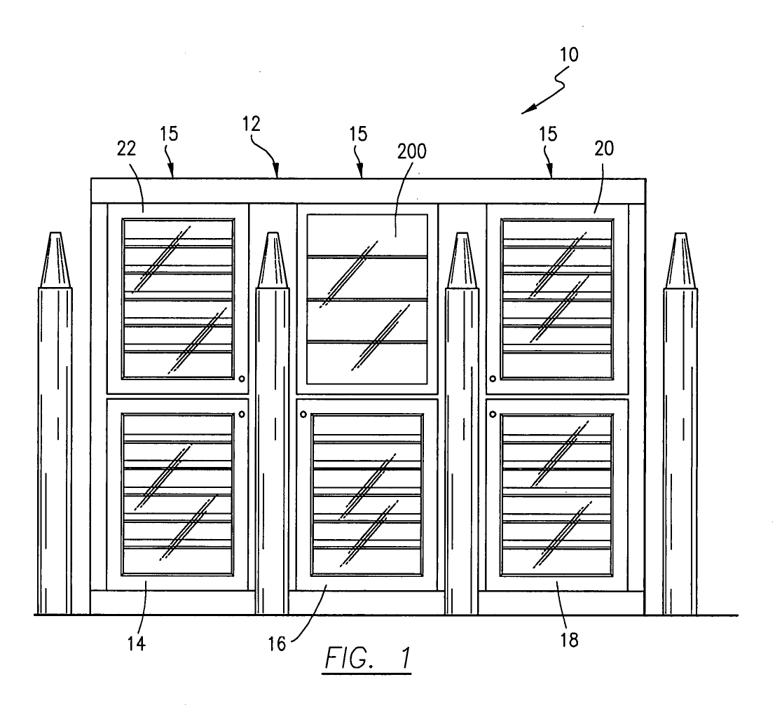

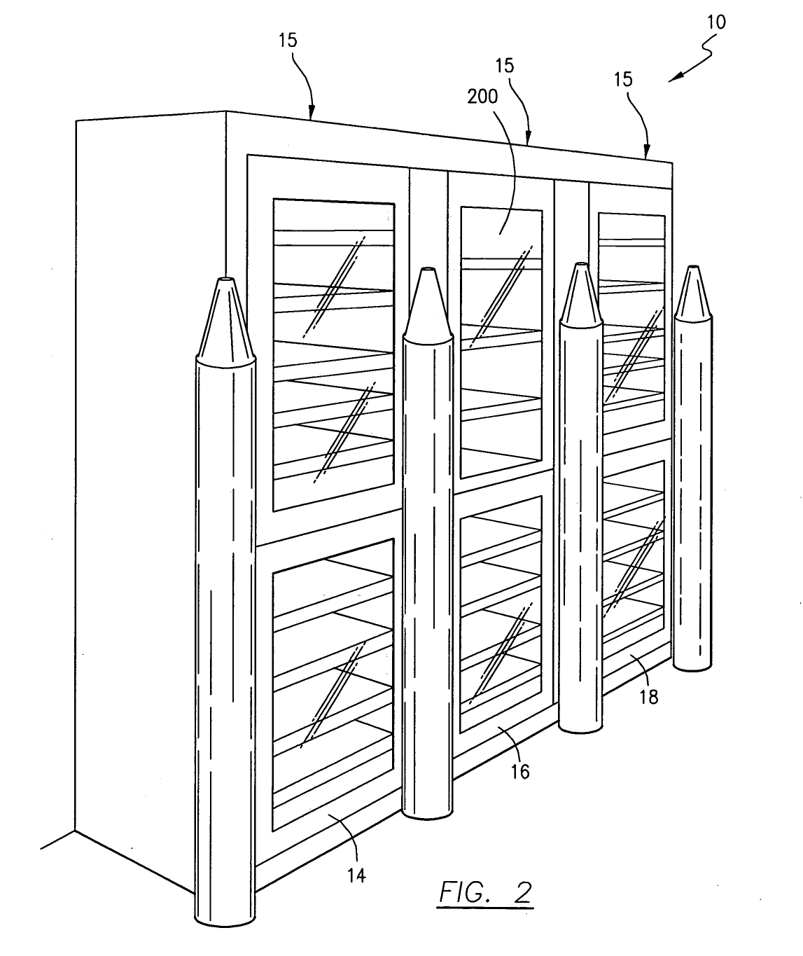

Referring to the drawings and, in particular, FIG. 1, the kiosk 12 used in the present invention 10 is shown. The purpose of the kiosk 12 is to store products that can be sold at a daycare center, pre-school or other environment that is utilized by young children. The kiosk 12 shown in FIG. 1 is typically sized so that it can be compact for the storage of goods which can be easily transported and mounted in selected areas of a daycare center. The kiosk 12 is narrow enough that it is suitable for hallways or for space along a wall in a designated room. As shown in FIGS. 1 and 2, the kiosk 12 is comprised of basically three vertical modular storage cabinets 15, each having lockable front doors 14, 16, 18, 20 and 22 that have plexiglass clear plastic windows and inside of each storage cabinet a plurality of shelves varied in height and width for the mounting of products that can be easily observed through the glass or plastic clear, transparent windows.

The center of the invention 10 includes a refrigerator 200 that is substituted for one of the cabinets having storage shelves. A full size-glass front refrigerator could be used for the entire vertical module.

The kiosk 12 is made in individual modules 15 that are vertically rectangular and that are pre-sized so that a plurality of individual stand alone storage shelves can be mounted together side by side depending on the size of the facility and the intended storage of goods required at a particular daycare center. This array provides compact storage.

As shown in FIG. 1, the kiosk 12 is comprised of three separate vertical modular storage units 15. The storage unit 15 on the left hand side includes an upper and lower shelving with two separate doors 14 and 22, each of which can be locked.

The storage unit in the middle has an upper refrigerator 200 that is the same size as the upper storage cabinet on the left or right and is mounted above the storage cabinet below. The right hand side also includes its own individual upper and lower lockable storage cabinets having doors 18 and 20.

Also attached (optionally) to the front of the unit in the upper right hand corner is a point of sale credit card reader activating device that identifies cards for credit card transactions. A cash register normally is used by an attendant for the sale of the goods. The attendant would also have keys to open each of the cabinet doors to allow access to the goods mounted therein. A cash register can be used with an attendant.

At the top of each storage cabinet on each side may be hooks or fasteners for mounting packaging bags for the transport of the goods being sold.

As an additional motivation for the children in the day school the entire unit has decorative indicia which as shown constitute four vertically standing columns that may be decoratively colored.

Although three units 15 are shown having three vertical separate storage areas vertically joined together as a single unit for stability, the size of the kiosk can be varied by additional units 15 stacked side by side.

As discussed above, the overall kiosk 12 is made quite narrow in depth so that the kiosk 12 can be located in hallways in a pre-school or daycare center. The overall rectangular shape is designed to provide compact but adequate display and storage of commonly purchased items in the storage cabinets that allows parents or other people who must transport children to and from children centers to avoid stopping and to avoid additional errands for shopping, especially for children.

Examples of some of the items that could be sold include baby items and baby foods, diapers for children, drinks that might be most used by children including certain types of baby fruit juices, milk, certain things such as aspirin or ointments that children may need such as Neosporin ointments, food products which include instant lunches, medicines especially of children's types of aspirin or Tylenol, benadryl, nutritional items and even snacks.

The amount of goods and the type of goods being sold can be varied. However, the purpose of the invention as stated above is to eliminate the need for a childcare provider that must transport a child back and forth to daycare centers and day schools that would avoid having to make extra stops getting out of the car and transporting a child through the stores.

FIG. 2 shows the relative depth of the kiosk 12 compared to the height of the kiosk and includes at one end horizontal pegs 21 that can be used to store bags or tote bags. Each separate vertical unit 15 can stand alone but includes a top flat covering board for holding all the units together in a single unit. The doors 14 and 16 are hinged such that each individual door swings outwardly from one side and include a key and lock on the opposite side so that each storage cabinet is basically locked unless the attendant is dispensing products for sale.

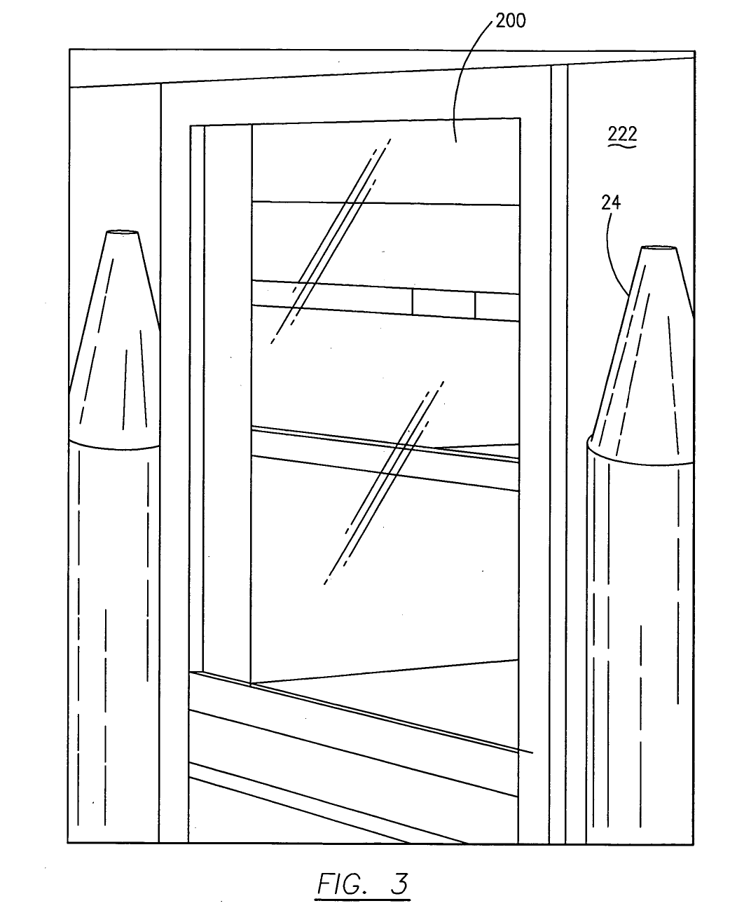

FIG. 3 shows a refrigerator 200 that is mounted in a space that is sized as upper storage cabinet shown next to it. There is a uniform size of cabinets throughout the entire kiosk 12 of both the upper storage cabinets and the lower storage cabinets. The refrigerator 200 also has a transparent glass or plastic front door so that people can see the products that are for sale there. The refrigerator 200 includes a lock on one side of the door.

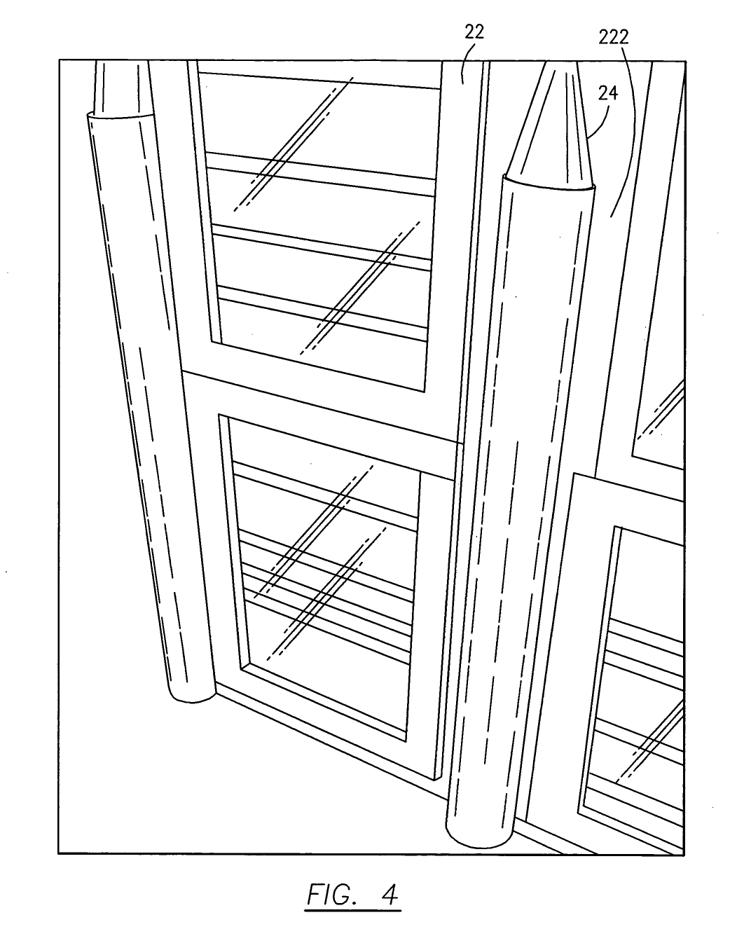

FIG. 4 shows the relationship between the lower cabinet door 14 and storage shelves and the upper cabinet door 22 and storage shelves of a single unit 15. Also shown are the key slots for the locks that allow each of the panel doors to be locked in place. A decorative sidewall cover 24 mounted on connecting board 222.

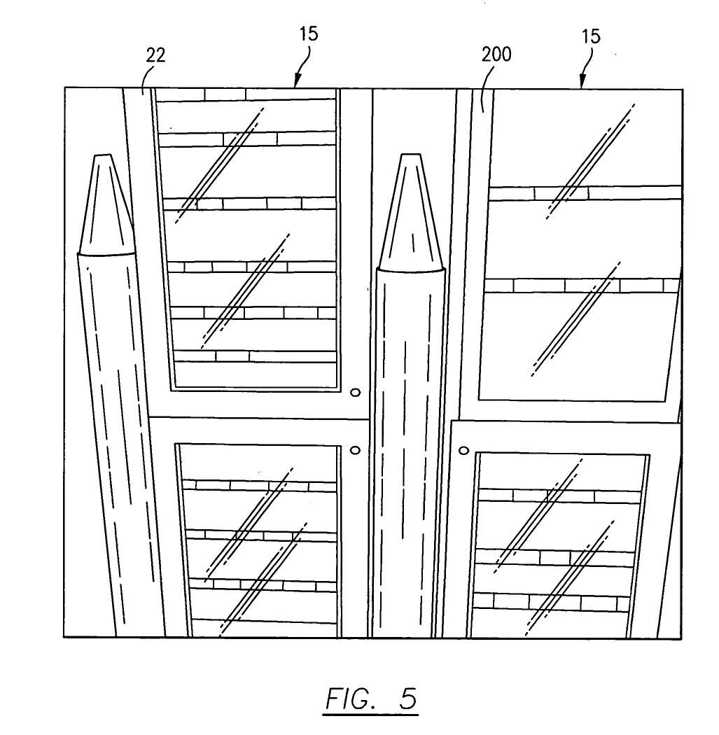

FIG. 5 shows the relationship between two adjacent kiosk storage units 15 that are fixed together including the outer units 15 that have upper and lower storage shelves and the adjacent panel that includes a refrigerator 200 on the top and the storage unit on the bottom.

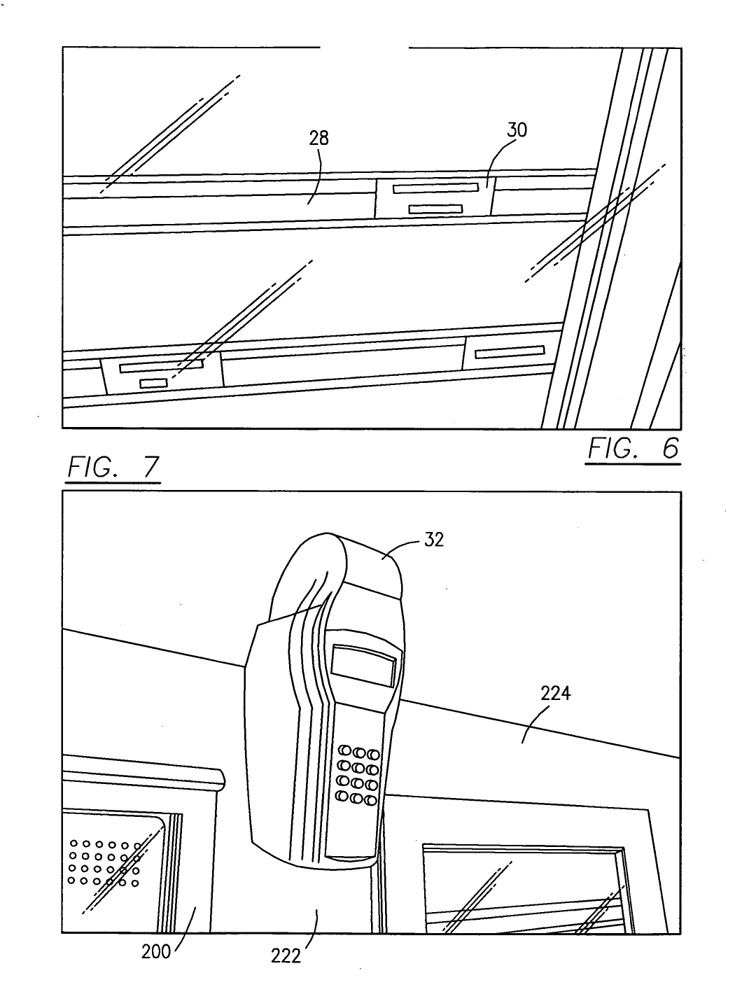

FIG. 6 shows an individual storage shelf 28 that includes a plurality of shelf markers 30 that are plastic rails that allow for the insert of changeable exhibiters that include various indicia that display what the particular product is and the price. Each of the shelves 28 has these easily removed indicia markers 30 which can be changed whenever necessary. Each of the markers is clearly visible through the plexiglass, plastic or glass panel doors so that potential customers can observe the particular goods available and their prices.

FIG. 7 shows an optional credit card reader 32 that allows for real time credit card transactions by swiping a credit card or could include a smart card that allows a particular amount of sales. This reader 32 is mounted on top of the upper connecting board 224 that connects the three vertical storage units 15 together.

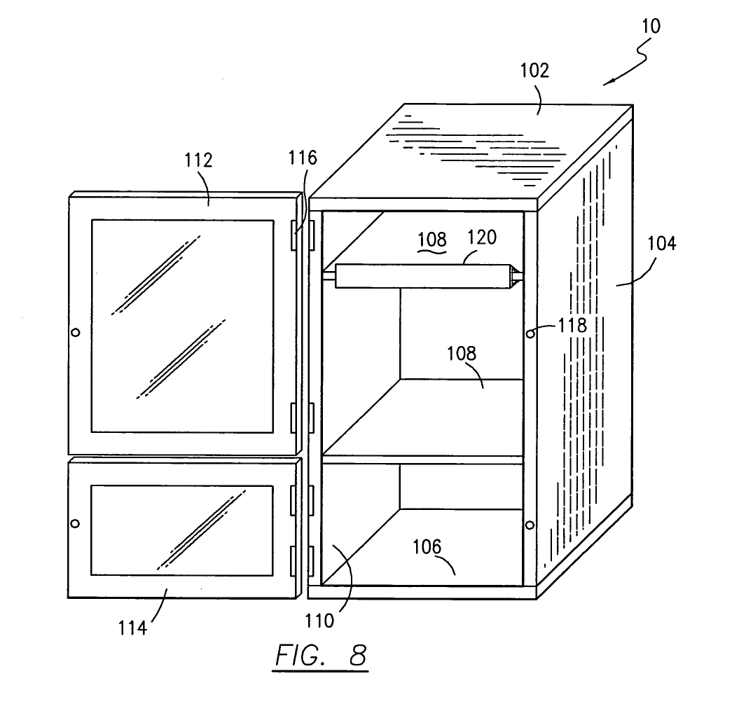

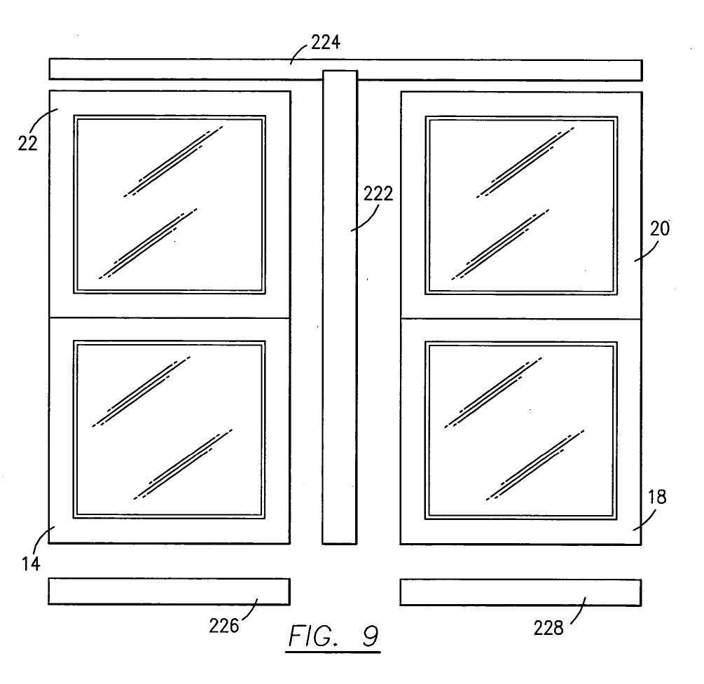

Referring to FIGS. 8 and 9, each individual storage cabinet 100 can be made of a rigid wooden or plastic sheet formed into rectangular panels 102, 104, 106 and 110 forming an enclosure 100 that is rigidly fastened together with screws or nails. The base floor 106 also includes a rigid panel that may include base mounts or foot mounts for supporting the unit 100 vertically. The cabinet doors 112 and 114 are mounted on one side with hinges 116 that permit the doors to swing open in a desired direction. The individual vertical storage units 100 may be joined by a horizontal top board 224 (FIG. 7) that extends across the front of the kiosk 12 that holds all three vertical units 15 together. Additional vertical boards 222 keep the units 15 together horizontally.

Referring now to FIG. 9, the relationship between individual vertical units shown by left doors 14 and 22 separated from doors 18 and 20 mounted vertically can all be joined together as a single unit using a vertical cross board 224 that connects two adjacent units together with screws, bolts or the like and a central vertical panel or board 222 that also joins the unit together between the left unit and the right unit. The base can be boards 226 and 228 that can be attached to the vertical board 222. The boards form rigid structural members that hold two or more vertical units side by side together for stability. This aids in the module nature of the entire structure so that individual vertical units shown before as units 15 can be added depending on the size of the institution or daycare center being used.

The decorative indicia 24 indicative of a child's environment makes the kiosk aesthetically acceptable in a daycare center. The indicia 24 FIG. 4 includes enlarged crayons made of molded plastic and firmly attached to the base board 222 that joins adjacent vertical storage units 15.

In an alternate embodiment, a drive through facility that sells primarily child care products is established. The exterior of the drive through building includes aesthetic figures for child enjoyment such as giant crayons to readily identify the building as a child care center store for convenience child necessities where the customer need not leave the vehicle. A drive through ramp with a covered roof protects the attendant who approaches the vehicle to deliver the items purchased by the driver in the vehicle. A child in the vehicle need not leave the vehicle. The same products sold at the kiosks described above can be sold. In addition, other services such as dry cleaning and children's laundry can be provided.

The crux of the invention includes the use of a point of sale product device for storing and enabling an operator to sell specific products in environments such as daycare center, pre-school, nursery school or even mall areas where children congregate to save additional errands and trips to shopping centers, convenience stores and the like by the parent that must transport the child to and from the activity center such as the daycare center. The business method also includes the method of installing one or more of these kiosks 12 with decorative indicia making it suitable for daycare environment such as decorative crayons or other childlike items making the unit attractive so that it blends into the environment of the daycare center without being just a commercial sales rack.

By providing for security and locked shelve space, the unit can be safely left in the daycare center and can be managed by a single operator that is available between certain designated times for the sale of the products involved. The particular emphasis of the products under this method of doing business is to employ products particularly suited for young children that are constantly in requirement by caretakers who must transport children back and forth to the children activity centers.

The sales could be accomplished with cash or credit that include charge gift value cards and include a merchant terminal for use of credit cards. The units would specialize in children's product and children specialties that include things such as children aspirin and diapers.

Each of the modules used that include an upper storage and lockable cabinet with shelves and lower storage cabinet with shelves is a stand alone unit that is joined together on site when the kiosk is installed.

In an alternate embodiment, the kiosk could be set up even in a shopping mall that would include a playground area and facility especially for children, a large sitting area for parents and children and a plurality of TV sets mounts on top of the kiosk that would include children's shows and feature mainly children shows. In this case, the attendant would then be in the sitting area and available for unlocking the cabinets for point of sale products.

The instant invention has been shown and described herein in what is considered to be the most practical and preferred embodiment. It is recognized, however, that departures may be made therefrom within the scope of the invention and that obvious modifications will occur to a person skilled in the art.

1. A method for greatly reducing the number of shopping errands required by children caretakers such as parents wherein children are being transported to and from a child activity center such as a daycare center comprising the steps of:
a. placing a product storage kiosk unit that includes at least one stand alone vertical module in a child activity center such as a daycare center;
b. placing child specialty products within the module for sale to visits to the child activity center; and
c. selling child specialty products to visits of the daycare center to eliminate additional shopping trips for child specialty products.

2. A system for providing child specialty products at a child activity center for sale to child caregivers who transport children back and forth to the child activity center comprising:
a first stand alone product storage unit;
a plurality of glass doors mounted on said vertical storage unit module;
a plurality of locks each of which can lock a different door of the storage doors;
child indicia mounted on said storage unit for providing an aesthetic appearance for a child activity center; and
a child activity center such as a daycare center including a hallway for receiving said kiosk.

3. A method as in claim 1, including the step of:
providing a drive through store selling child specialty products having a child pleasing aesthetic exterior appearance.
